(19) United States
(12) Patent Application Publication
(10) Pub. No.: US 2002/0087945 A1
(43) Pub. Date: Jul. 4, 2002

(54) System and method for providing flexible network service application components

(76) Inventors: Donald Brent Marshall, Ottawa (CA); Elaine Ee Lay Quah, Nepean (CA); Lejla Eminovic, Nepean (CA)

Correspondence Address: Hunton & Williams, 1900 K Street, N.W., Washington, DC, 20006-1109, US

(21) Appl. No.: 09/749,938

(22) Filed: Dec. 29, 2000

(51) Int. Cl. G06F 9/44

(52) U.S. Cl. 717/107; 717/109; 717/113

(57) ABSTRACT

The flexible service application components (“FSACs”) of the present invention enable services to be defined by logic and data, as well as other functions, such as operations, administration, and management. The flexible service application components of the present invention enable a service designer (and/or other entity) the ability to create an integrated component that represents a service feature. Thus, a FSAC may be developed to encapsulate protocol-specific interactions and present a homogenous interface to a feature FSAC. Hence, the present invention enables application-level FSACs that may be protocol-independent.

### FIELD OF INVENTION

The present invention relates generally to software components, and more specifically to flexible service application components that enable a service to be developed, provisioned, managed and maintained as a separate entity with a well defined external interface, specified by events that are imported and exported and/or the specific points at which interaction occurs with other components.

### BACKGROUND OF THE INVENTION

In networks, there may often exist incompatibilities among various components and other hardware. For example, in a wide area network, different servers, databases or communication links may have different requirements which, if substituted, may interrupt communications.

In a cell phone network, different cell phone equipment may have varying requirements for proper and efficient communication. Generally, a cell phone (or other communication device) may transmit to a mobile switching office which may be used to translate phone numbers (or other identifiers) to connect the transmitting party to the desired one or more recipients. The mobile switching office may receive cell phone (or other) transmissions and route the transmissions to the network, resource (e.g., database) or other entity. Generally, a server may be configured to format to a specific database (or other resource). Each component of a network is dependent on each other for compatibility and proper communication.

If a database (or other resource) is to be removed (or otherwise modified), reconfiguration of the server and other components may be required. A resource, for example, may include anything which may be needed for a service to execute successfully, such as a database, network addresses, switches, hardware, software, control logic and other components. This may entail downing the system, making the necessary modifications, loading software, rebooting, and performing other additional operations. Thus, if a phone server (or other types of resources) are modified (e.g., upgraded, etc.), changes in hardware and other components in a mobile switching office or other network elements may be necessary.

Currently, modifications (including upgrades) in a network (such as a cell phone network) are difficult and time consuming due to the dependency on components within the network.

Essentially, every device (including hardware and/or software) in a chain had to know of devices in the rest of the chain to obtain the requested information. Therefore, modifications and upgrades have been difficult and tedious because components are dependent on hardware and other components within a network. Generally, system crashes and other impediments occur when modifying resources, such as upgrades in databases.

A service may encompass an application or a set of interworking features that may be used to provide a user with a final result. For example, a service may include the use of time or origin of a telephone call to determine where the call is being routed. In IP applications, a service may provide a user with unified messaging. For example, unified messaging may include accessing voicemail, email and pages through a communication device, which may include a computer, telephone, etc. An e-commerce application may provide an HTML, WML, or voice menu interface, all of which interface to service logic which controls a shopping cart component, an inventory system, a shipping order management system, and a billing transaction engine. Other applications may also be implemented. Each of these components may be implemented as a separate reusable software entity.

Current services may be defined by logic and data associated with services. The logic and data may be what is generally visible to the end user. A service may be managed from an operations, administration and management (“OAM”) point of view. For example, a service may manage its contexts or state with relation to a particular call. A service may also provide obvious points where the service may interact with other services.

Current services may tend to be either hard-coded or difficult to adapt. For instance, services may be intrinsically linked to protocols that are used which may result in multiple versions of the same service, even though the same or similar tasks are being performed. This generally results in inefficiencies and increased costs.

A service-independent building block (“SIBB”) may generally be implemented at a finer granularity. This generally results in services with hundreds of SIBBs. In addition, the SIBBs tend to be protocol-specific and network-dependent resulting in a service that has to be customized for different protocols and network topologies. SIBBs are also unable to maintain context/state and as a result, are unable to accept multiple inputs at different times and react differently to each one.

Service Logic Execution Engines (“SLEEs”) in Intelligent Networks (“IN”) generally deals with the logic and data of a service. However, SLEEs may not handle other functions encompassed by a service, such as management, context management, interfaces, etc. This deficiency may result in proprietary definitions of a service and a requirement to cobble together the missing functionality. Furthermore, SLEEs may not adequately address how services may work together to perform combined functions transparently. This typically requires one or more services to be modified to support the interworking. In addition, SLEEs may not enable services to be created in a protocol or network topology independent way. This may require services to be modified when they must be deployed into different types of networks, even though the service may be providing the same (similar or related) functionality.

Enterprise Java Beans (“EJBs”) are generally designed to be stand-alone features that execute a particular task, e.g., a shopping cart service. However, the current EJB specification does not address how entity beans relate to one another. This means that entity beans must refer to one another using specific remote method invocation (“RMI”) interfaces. Thus, in order to integrate EJBs into an application, they must be directly coupled via specific method interfaces. Furthermore, EJBs do not allow context-independent logic to be defined. Instead, such logic is implemented by the EJB Container. This prevents EJB designers from being able to specify (for example), how an entity bean should be retrieved, or to allow a session bean to execute different logic variants based on how it is invoked. Furthermore, EJBs are not individually managable via OAM systems. There is no way for an EJB designer to affect how it appears or behaves from an OAM perspective. Typically, EJB Containers are managed as monolothic entities, with no way of determining how well specific EJBs within them are performing.

Other solutions, including compiled services and programmed services, provide no or a minimum amount of flexibility.

### SUMMARY OF THE INVENTION

A method and system for flexible service application components (“FSACs”) of the present invention enable services to be defined by logic and data, as well as other functions, such as operations, administration, and management, for example.

According to the present invention, FSACs may be defined as a self-contained unit of application functionality where various aspects of behavior of an application functionality may be encapsulated within an FSAC and transparent to outside and other entities.

The present invention further enables a FSAC to be developed to encapsulate various protocol-specific interactions and present a homogenous interface to other FSACs and other components. Thus, application level FSACs may be protocol independent.

The present invention further enables a FSAC to provide user interface presentation that may be independent of service logic.

The present invention further enables a customer (or other entity) to alter existing connections with a wiring tool or other mechanism. This enables service providers (and other entities) the ability to create service variants without having to purchase or create additional software.

Other objects, features and advantages of the present invention will be apparent through the detailed description of the preferred embodiments and the drawings attached hereto. It is also to be understood that both the foregoing general description and the following detailed description are exemplary and explanatory and not restrictive of the scope of the invention.

### BRIEF DESCRIPTION OF THE DRAWINGS

FIG. 1 is a diagram of an architecture which may support an open programmability environment, according to an embodiment of the present invention.

FIGS. 2-5 illustrate the establishment of event communication channels, according to an embodiment of the present invention.

FIG. 6 is a diagram of an application component, according to an embodiment of the present invention.

FIG. 7 is an illustration of event portals, according to an embodiment of the present invention.

### DETAILED DESCRIPTION OF THE PREFERRED EMBODIMENTS

The present invention relates to a method and system for addressing incompatibility issues related to hardware and other components in a network. The present invention enables a network (e.g., cell phone network) to be programmable at a higher level without restructuring or tearing down an existing system. Thus, the system of the present invention provides improved reliability by minimizing system crashes; facilitates upgrades, additions and deletions; and provides other advantages.

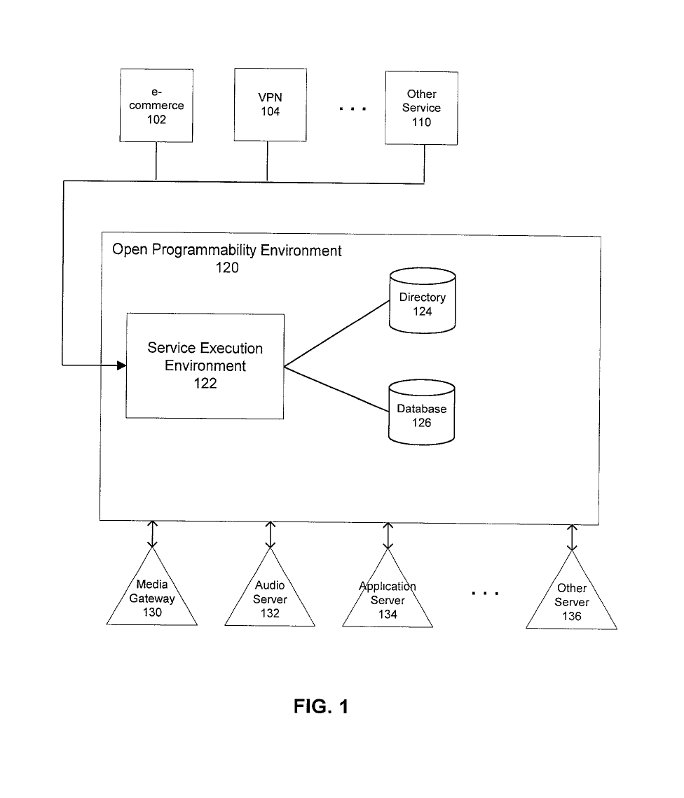

FIG. 1 illustrates an example of an architecture for supporting a system providing an open programmability environment, according to an embodiment of the present invention.

An open programmability environment 120 of the present invention provides an environment where, among other things, hardware components do not need to be hardwired to other specific types of components for communication. Instead, various data structures and control logic may be processed in order to establish proper communication with varying and multiple devices. Thus, data of differing types and variations may be received and processed without restructuring or reconfiguring the overall system.

The open programmability environment 120 of the present invention may include hardware, software, communication and other resources. As illustrated in FIG. 1, the open programmability environment 120 may support resources including a service execution environment 122, Directory 124 and Database 126. Other resources may also be included. Generally, a resource may include anything which may be needed for a service to execute successfully. For example, in a telephone network implementation, a resource may include a database, network addresses, switches, and other hardware, software, control logic or other components used to support connections. Other implementations, variations and applications may be used.

A variety of services may execute within the Service Execution Environment 122 of the Open Programmability Environment 120. These services may include, for example Virtual Private Network (“VPN”) 104, e-Commerce 102, and other service 110. These services may be accessed by a variety of means including web browsers, mobile phones, voice menus, etc.

Back-end processing may occur, for instance, through Media Gateway 130, Audio Server 132, Application Server 134, and other servers 136.

According to an embodiment of the present invention, an application component may include an encapsulated unit of functionality which may be wired (or otherwise connected) together to create a service (or application). An application component may contain a collection of software components (e.g., beans) , or it may be coded directly in a programming language (e.g., Java). Other options or variations may be implemented.

The present invention enables the creation of service functionality which is portable, re-usable, and context-independent. According to the present invention, units of functionality may act as components which may be assembled into cohesive services, without requiring modification to the existing components.

Flexible service application components of the present invention may enable the definition of a feature of a service to be developed, provisioned, managed, and maintained as a single entity. Further, flexible service application components may have a well-defined external interface, specified by events that may be imported and exported and specific points at which it may interact with other application components. Further, flexible service application components may manage its own contexts, e.g., maintain state and other information for each transaction.

The FSAC of the present invention may enable a service provider to deliver to the market faster, cheaper and more efficiently. By opening up the creation and definition of application components to third party vendors and other authorized entities, services that interwork with FSACs created by third party vendors and other entities may be delivered. For some applications, a service may be composed of multiple FSACs. Parts of a single service may be developed separately by different designers, leading to more efficient, parallel development. Thus, a service provider may deliver a service more expediently and more efficiently.

As each service application component is an independent entity, each component may be tested separately and more thoroughly. As a service application component states the expected incoming and outgoing events, there are fewer unknown interactions, leading to reduced problems at and beyond delivery. In addition, there is a higher probability of re-use because FSACs may be protocol-independent and network-independent. Further, as a service may consist of multiple FSACs that may be connected via configured wires, a new service may be created via configuration alone. Thus, the service solution of the present invention provides an attractive service solution to providers. Also, flexibility and control as well as the ability to deploy their own or third-party services may lead to increased sales to service providers.

FSACs may be defined as a self-contained unit of application functionality. Various aspects of the behavior of application functionality may be encapsulated within a FSAC, and may be further transparent to outside and other entities. These aspects may include one or more of context independent logic and state, context specific logic and state, management (OAM) behavior, persistent data schema and other information. The context specific logic and state may have any number of variants, referred to as “templates”, which may differ arbitrarily from each other. The specific template (if any) which may be applied to a given transaction may be selected by an FSAC's context free logic, according to an arbitrary algorithm defined by a FSAC designer or other entity. If an FSAC has only one template, and no context free logic, that template may be applied by default to each transaction, according to an embodiment of the present invention. A façade may read in each template and instantiate ‘n’ number of them depending on configuration and other information where each of these instances may be referred to as a context.

Each FSAC may present an interface which may be defined during its creation or other point in time. The FSAC's interface may consist of any number of Event Portals, as defined by a FSAC designer or other entity. Each Event Portal may send and receive specific events, defined by an FSAC designer or other entity. In addition, FSAC interfaces may include importing or exporting specific data items as well as other operations.

Each FSAC may be defined by an arbitrary Service Creation Environment (“SCE”) . For example, an FSAC may be defined by connecting JavaBeans in a BeanBox tool. Other defining schemes may be implemented. In addition, FSACs may be created by coding directly in Java or other programming languages.

Once a set of FSACs have been defined, relationships between FSACs may be defined using a “Wiring Tool” or other mechanism to create applications. The Wiring Tool may be used to connect the outgoing events from one Event Portal to the incoming events of an Event Portal on another (or the same) FSAC. Furthermore, the Wiring Tool may connect the exported data items from one FSAC with imported data items on another (or the same) FSAC.

One or more FSACs which have been connected according to the present invention may then be deployed to various execution and other environments to make the application available to end users and other entities.

The flexible service application components of the present invention enable a service designer (and/or other entity) the ability to create an integrated component that represents a service feature.

Also, a FSAC may be developed to encapsulate various protocol-specific interactions and present a homogenous interface to other FSACs and other components. Hence, this feature of the present invention enables application-level FSACs that may be protocol-independent.

For example, separate FSACs may be defined to handle one or more of AINO.2, CS-1R, Parlay, and JAIN JCC, for example. Each of these FSACs may implement protocol specific logic, state, and message encoding/decoding, as well as other operations. Each may present an event interface (via one or more Event Portals) which may send and accept the same (similar or related) events for equivalent (similar or related) operations. For example, FSACs which translate protocols to normalized event interfaces according to the present invention may be referred to as “Adapters”.

According to another embodiment of the present invention, another use of FSACs may be to provide user interface presentation that may be independent of service logic. For example, separate FSACs may be created which may present interfaces in HTML (for example, using JavaServer Pages (“JSP”) or other means) , interactive voice menus using DTMF or speech recognition, and implement specialized GUI client interfaces. Other applications may be implemented. Each of these FSACs may accept and send the same (similar or related) events to provide a normalized interface to service logic. Thus, a service may request that a particular piece of information be presented to, or collected from, an end user, without needing to be aware of the details of the user interface presentation mechanism. This allows services to be accessible by multiple different access mechanisms (e.g., Internet, handheld PDAs with specialized client software, voice menus accessible via 800 numbers, etc.). Such services may therefore present the same (similar or related) operational characteristics, and use the same (similar or related) user profile, regardless of access mechanism.

As FSACs have clearly defined inputs and outputs, FSACs may be developed independently in accordance with the present invention. This feature of the present invention enables third-party application vendors (and/or other authorized entities) to develop services and features separately and independently. Such FSACs may be provided independently, or in pre-wired configurations to service providers, so that FSACs may be deployed for use in networks.

A customer (or other entity) may be provided with a wiring tool (or other mechanism) to alter existing connections as necessary, as network and/or other requirements and factors change. Therefore, customers and other entities may be provided with the flexibility to change (and otherwise modify) services configuration without returning to the vendor (or other entity) through the present invention. This gives service providers the ability to create novel service variants without having to purchase or create additional software.

Furthermore, service providers themselves may create FSACs. They may wire service provider FSACs together with those from various vendors to provide different services and options. This may be facilitated by the defined interfaces of FSACs, and the encapsulation of implementation details and other information within FSACs themselves.

Once an FSAC is defined, different logic and state variants (e.g., templates) may be subsequently defined and deployed into it. This provides vendors and service providers flexibility to provide customized variants of a service. For example, a service provider may have deployed a Virtual Private Networks (“VPN”) service to a network. A new customer of that service provider may require (or desire) a specific new variant of the VPN service with a new combination of features or other variation. A template which provides the required combination of features may be deployed to the VPN FSAC. The VPN FSAC's context free logic may select a template based on an originating and/or terminating address. The originating and/or terminating address of the new customer may be provisioned such that a newly defined template may be selected for the new customer.

FSACs of the present invention further enable the interworking of services. Generally, interworking of services requires a designer to modify existing services to enable the modified services to correctly interact with other services. However, the FSACs of the present invention do not need to be aware of where an event originates from or where it is sent. Thus, the late binding allows a service to interact with other service FSAC as easily as protocol FSAC.

For example, a Freephone (800) telephony service may be deployed to a service provider's network. That service may accept an event (e.g. RouteCallEvent) which may request that a call be routed to an “800” or other type of telephone number. The FreePhone FSAC may accept that event, and perform a mapping of the 800 number to an actual destination number using arbitrary (or other) logic and data. The Freephone FSAC may then send an event (e.g., RouteCallEvent) out requesting the call be routed to the new number. In a simple 800 example, that new RouteCallEvent may be “wired” to a protocol FSAC which may then encode an appropriate message to cause the call to be routed.

Similarly, a Local Number Portability (“LNP ”) FSAC may accept and generate events (e.g., RouteCallEvents) to cause a number which has been moved to a new telephony access service provider to be routed appropriately. In a simple LNP case, the LNP FSAC may be wired to a protocol FSAC, which sends the appropriate message (and/or other related data).

A service provider may wish to cause 800 and LNP to work together, such that the actual number to which an 800 call is routed may also be ported to a new telephony access service provider. This may be referred to as “service interworking”. To accomplish this, the 800 FSAC and LNP FSAC may be wired together such that the RouteCallEvent which is sent out by the 800 FSAC becomes the input event for the LNP FSAC. The LNP FSAC may then be wired to the protocol FSAC to cause the call to actually be routed. Thus, the interworking of these two services may be accomplished without requiring modification to either of the services, by configuration.

Likewise, a single service may consist of several “interworking” FSACs which may be independent of each other, and “wired” together to collectively provide the desired service functionality. This may be advantageous for a number of reasons. For example, the logic and state of two parts of a service may vary independently of each other. An example of this may include a telephony VPN service. Telephony VPN typically involves a set of features which may be associated with an originating caller, and a separate set of features which may be associated with the terminating caller. Each originator and/or terminator may select different features to be applied to their outgoing and/or incoming calls. To accomplish this, a separate Originiting VPN FSAC and Terminating VPN FSAC may be defined. When a VPN call is placed, the context free logic of the Originiting VPN FSAC may select an appropriate template for the originating caller based on the calling number. When the originating logic has decided to route the call, it may send an event, which may be “wired” to the Terminating VPN FSAC. The context free logic of the Terminating VPN FSAC may then select the appropriate template for the terminating caller.

Part of the definition of each FSAC may encompass management (OAM) behavior. For example, each FSAC may be given basic default behavior which may allow the FSAC to be deployed, started up, shutdown, locked, unlocked, etc. by an external element manager. Other operations may be performed. Using the dependency management infrastructure as, for example, mentioned in the aforesaid co-pending U.S. patent application Ser. No. ______ , titled “System and Method for Managing Dependencies in a Component Based System” and management system as, for example, mentioned in the aforesaid co-pending U.S. patent application Ser. No. ______, titled “Method and System for Integrated Resource Management” a collection of inter-working FSACs representing a service may have their state aggregated to appear as a virtual network element.

In addition, FSAC designers may specify additional OAM attributes and behavior. They may define configuration items, Operational Measurements (“OMs”), logs, etc., which the FSAC may use based on the definitions, behavior specified by the FSAC designer and other information. Furthermore, the management state and alarms associated with the FSAC may be set by arbitrary logic defined as part of the FSAC in the its management logic.

Flexible Service Application Components of the present invention may include a façade, event portals, contexts and/or other components. The façade may provide the externally visible interface to the FSAC, by presenting event portals which may accept and send specific events. Event portals may act as entry and exit gateways for the application component. Contexts may contain application logic and data which may be associated with a particular transaction. According to an embodiment of the present invention, the façade may read in each template and instantiate ‘n’ number of them depending on configuration and other information where each of these instances may be referred to as a context.

A façade may encapsulate context-free logic and state which may not be associated with any service context. Thus, a façade may not have any state information associated with a single specific context.

Events may be sent to application components and received from application components via specific event portals. An event may be an object which may be used to communicate details of a particular occurrence. For example, an event may represent protocol messages, timeouts, notification of a state change, a request for a particular service, the result of such a request, and other objects. Also, software components (e.g., JavaBeans) may generate events to signal occurrences which may be processed by other software components (e.g., JavaBeans or other objects).

Each invocation of a service (or transaction) of which an application component is part may have its own state. Software components (e.g., JavaBeans or other objects) which may exist within the context of an application component may store the state for a particular service invocation internally, and may be unaffected by other service invocations. Thus, contexts may be transparent to software components (e.g., beans) or other objects which may be used to implement context-specific logic and state of an FSAC. Whether or not a particular application component uses contexts is not important or visible to other application components which may be working with contexts.

The contexts for each application component involved in a particular service invocation may be maintained in a context envelope so that when beans within the context of application components which are wired together communicate, corresponding contexts are ensured proper communication.

There are many context instances that may execute within each application component. A managed object interface may act as the OAM interface and manage the FSAC. At execution, the runtime system may be looked at as a series of interacting FSACs.

The combination of the façade and event portals in the FSAC may allow for the postponement of connection/wiring of FSACs to a time after the FSAC is created. Through the use of a wiring tool or other mechanism, multiple FSACs may be connected together. For example, wiring definitions may be uploaded to a service execution engine (“SEE”) which may then create the actual connections. The FSACs may now be able to communicate with each other.

Each FSAC may contain many portals for information exchange to and from the FSAC. Event portals may have a facet which may be presented to the outside world via the façade (which may be referred to as Facade Event Portals). Event portals may also have a facet which may be presented to the context specific logic (which may be referred to as Context Event -Portals). Thus, each externally visible event portal on an FSAC may be implemented as a single Façade Event Portal, and an instance of Context Event Portal on each context.

Event wiring between FSACs may define one or more connections between the event portals. Wire definitions may be used to create runtime references between the Façade Event Portals at startup, initialization time, or at other occurrences or time periods. In addition, references between Context Event Portals may not be created at startup or initialization time. This is because it may be difficult to determine a priori which combination of FSACs may be involved in transactions. This may be controlled by the execution logic within the FSACs, which may be beyond the control of the SEE. In particular, when there are different variants of context specific logic (e.g., templates) which may potentially be involved in each transaction, there may be a potentially unmanagable number of possible combinations of template variants.

The present invention addresses this issue by performing runtime binding of context event portals according to the defined event wires, and the actual runtime event passing of the FSACs involved on a particular transaction.

When an initial event is passed from one FSAC to another for a particular transaction, it may go to a Façade Event Portal. The context free logic of the FSAC may then process the event, and as part of that processing may choose to invoke a specific template. When this occurs, the template (e.g., context) may be added to a context envelope for the transaction. Further, the event portal on the FSAC which sent the event may be bound to the context event portal on the template which was added to the context envelope. Thus, a transaction specific communication path may be established directly between the context event portals of the FSAC context associated with a particular transaction. The result is that the contexts of the different FSACs may execute in arbitrary combinations at runtime, with optimal inter-context communication.

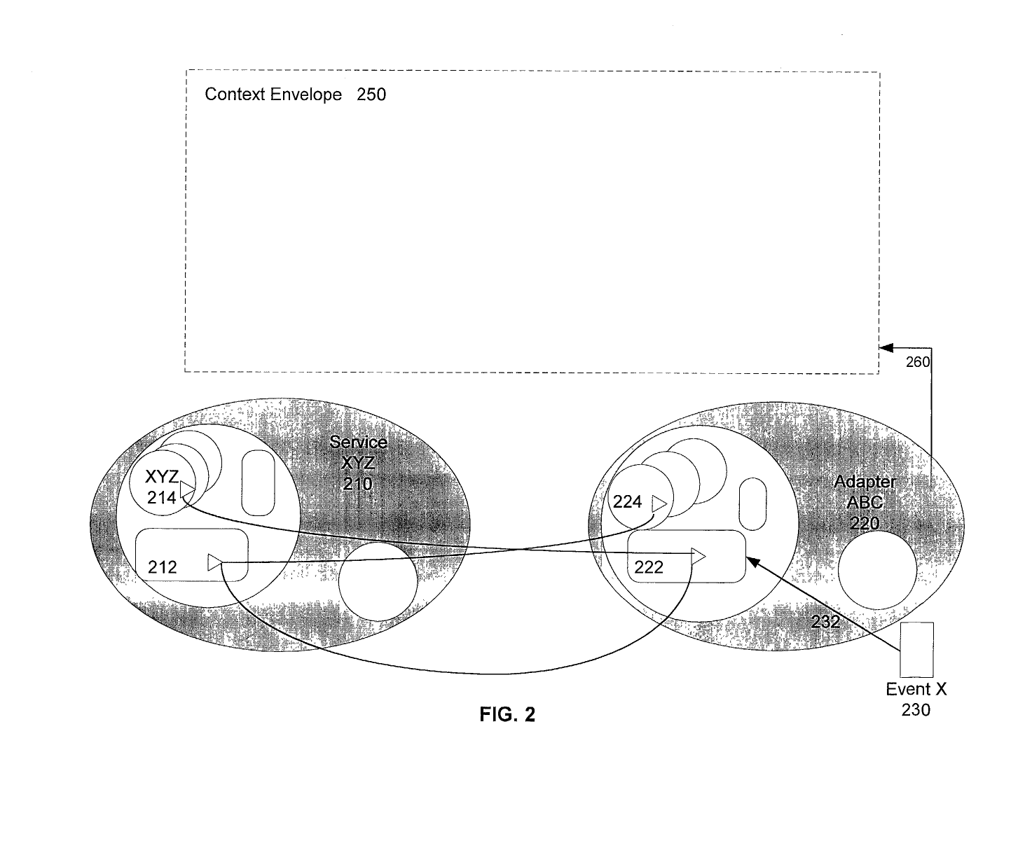

FIGS. 2-5 illustrate the establishment of event communication channels, according to an embodiment of the present invention. Context management may include the process of maintaining a set of resources for a given transaction. Resources may include contexts (e.g., instances of template), events, data values and other objects. The mechanisms that may be used to provide context management may be a part of the service execution environment (“SEE”).

For each event wire, the managed resource may first establish event communication channels from its façade event portals to the destination AC's façade event portals. Then using the same (similar or related) event wire information, the managed resource may replicate the event communication channels for each of its peer context event portals to the same destination AC's façade portals.

FIG. 2 illustrates steps in the establishment of event communications, according to an embodiment of the present invention. After a startup sequence, event wires may be established between two application components. Event X 230 may be from source that is external to the service execution environment. Event X 230 may arrive at Adapter ABC Application Component's façade event portal 222, as shown by 232. Adapter ABC may further comprise context 224. It may be responsible for sending and receiving events from an external source to the service execution environment via an arbitrary transport mechanism.

Adapter ABC façade 222 may then recognize that it is an initial event. At this point, it may instantiate a context envelope 250, as shown by 260. Examples of an “external source” may include communication servers (e.g., Media Gateway Controllers, Media Gateway routers), other application servers (e.g., web servers, e-commerce billing servers, etc.), client devices (e.g., desktop computers, PDAs, mobile phones, etc.) and other sources. Context Envelope 250 may be a single-threaded entity. Any resource that executes within a context envelope may execute in the same thread. There may be more than one context envelopes active in the system at any given time, each representing an active transaction. Service XYZ 210 may include XYZ façade 212, XYZ context 214 and other components.

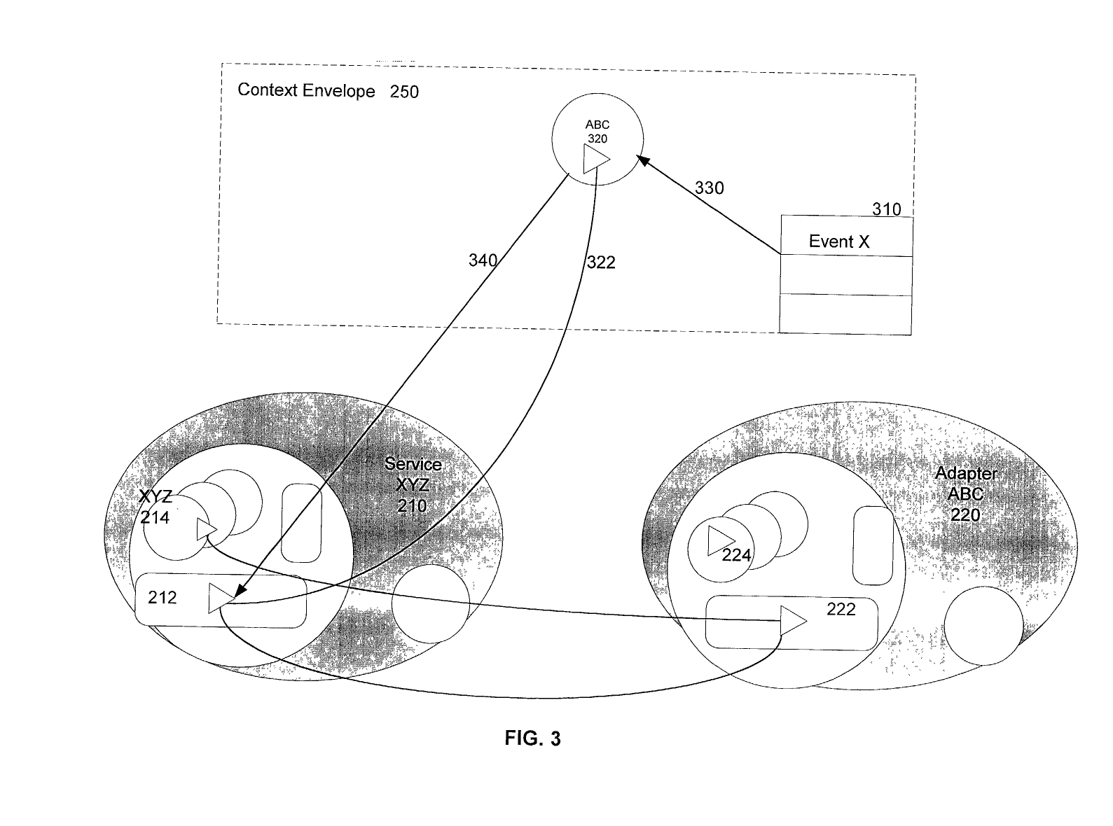

FIG. 3 illustrates steps in the establishment of event communications, according to an embodiment of the present invention. Adapter ABC Façade 222 may place Event X onto the context envelope's event queue 310. Context envelope's event queue 310 may be intended for incoming external events. Adapter ABC Application Component's Facade 222 may then place one of its contexts from 224 inside the context envelope 250, as shown by 320. The Adapter ABC context 320 may then pick off Event X from the event queue 310, as shown by 330. Via its event wire 322, Adapter ABC context 320 may send event X to service XYZ's façade event portal 212, as shown by 340.

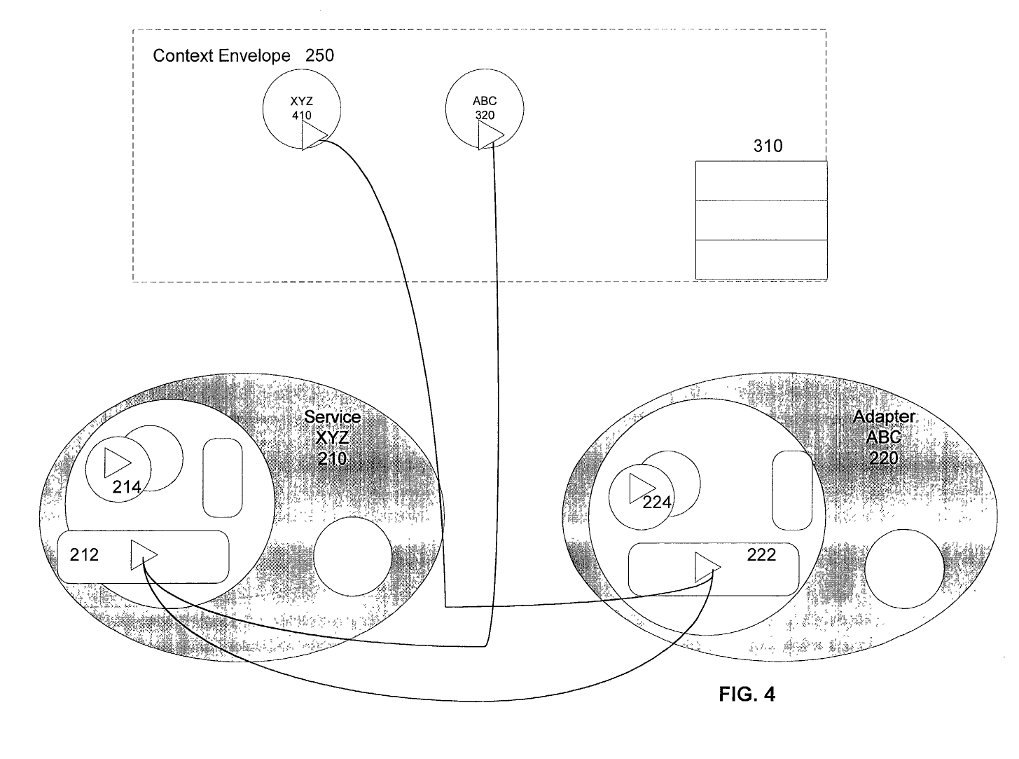

FIG. 4 illustrates steps in the establishment of event communications, according to an embodiment of the present invention. Service XYZ 210 may execute the context-free logic within its façade 212. Part of that logic may determine the type of template to handle event X. Other operations may also occur. Service XYZ's façade 212 may place an instance of a determined template type (e.g., context) from 214 into the context envelope 250, as shown by 410. Event X may also be transferred to the context's event portal.

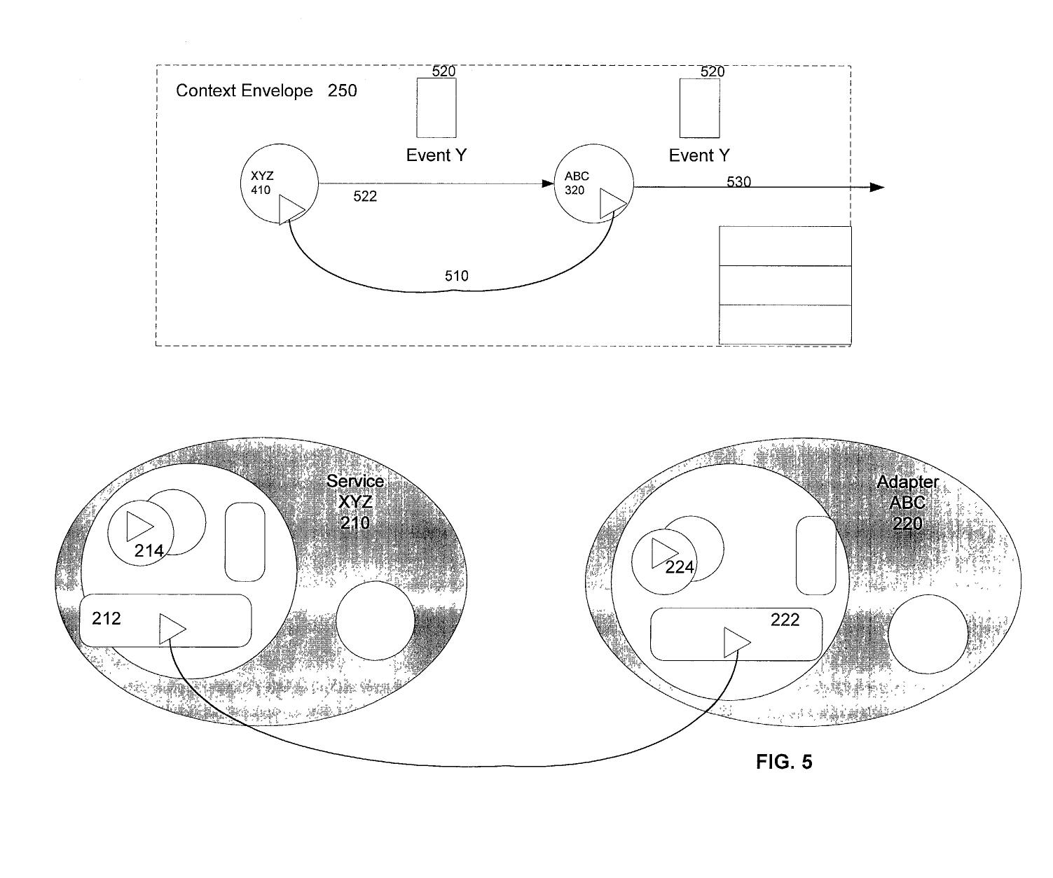

FIG. 5 illustrates steps in the establishment of event communications, according to an embodiment of the present invention. The event wiring of the contexts within the context envelope 250 may be changed so that an event channel 510 may be established between the context event portals of the XYZ context 410 and the ABC context 320. This step may be referred to as “dynamic” event wiring. Originally, after Application Component (“AC”) initialization, an event channel may be established between context event portal of one AC to façade event portal of another AC. During the execution of a transaction, this event channel may be dynamically changed so that it is from the context event portal of one AC directly to the context event portal of another AC. This change may be done so that the various contexts executing with a context envelope may communicate with one another directly without going through the façades. This provides various run-time performance benefits.

Context XYZ 410 may execute its logic to handle event X. Via the event wire 510, context XYZ 410 may send out event Y 520 as a response to ABC context 320, as shown by 522. Context ABC 320 may send event Y 520 external to the service execution environment via an arbitrary transport mechanism, as shown by 530.

This approach provides many advantages. For example, FSACs that are network-independent may be created and implemented. Therefore, a FSAC does not need to be aware of the topology, or the specific node types of the network on which it may reside. For example, a FSAC does not need to know if there is a particular switch the FSAC has to communicate with. Rather, the FSAC may indicate that it expects a particular event from a particular portal, rather than the specifics involved. This further enables a designer to create (or design) an FSAC once and use that FSAC in a wide variety of implementations because the FSAC is not hardwired to a specific input and/or a specific output. Further, the FSAC may be used by multiple customers (or other entities) regardless of network topology and other specifics. This feature of the invention further reduces the cost and burden of FSAC creation. Similarly, protocol-independent FSACs may also be created and implemented. Similar to network independence, communications may be accomplished through events so that a protocol FSAC may be plugged into the portal to translate protocol messages into events that the FSAC may understand.

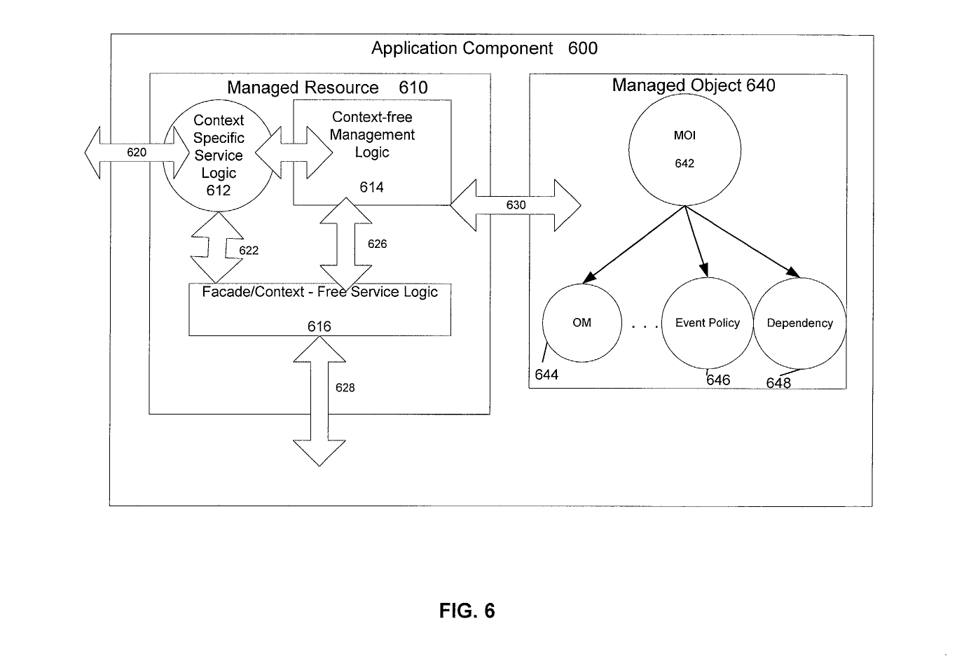

FIG. 6 is an example of an application component, according to an embodiment of the present invention. Application component 600 may encompass a unit of encapsulation that may contain logic that may be executed by various parts of the system of the present invention. According to this embodiment of the present invention, an application component may include Managed Resource 610 and Managed Object 640. Other units may be included. Generally, a service or other application may be composed of one or more application components.

Managed Resource 610 may include various components. For example, a managed resource may comprise a context-specific service logic 612, a context-free management logic 614 and a façade/context-free service logic 616. Other components may also be included. Each part of the managed resource may communicate externally and/or to other parts via events or other communication mechanism. A managed resource may have multiple templates where each template may be instantiated multiple times.

Context-specific service logic 612 may be an instance of a specific template. For example, it may contain a collection of context event ports that may be a subset of a collection of façade event portals. Other combinations may also be utilized.

As for context-free management logic 614, each bean within the context-free management logic may act as a proxy to invoke specific functions within a managed object. Communication to a managed object may be established by event 630 or other means of communication.

Façade 616 may contain context-free service logic, for example. According to an embodiment of the present invention, context-free service logic may execute when an event first enters an application component. Other triggering events may also be defined. As part of executing the logic, façade 616 may decide that execution should continue in other parts of the managed resource, such as context-specific logic and other parts.

Each part of the application component may communicate externally and/or internally through events. For example, event 620 may establish communication between context-specific service logic 612 and other application component's context-specific service logic. In another example, event 622 may establish communication between context-specific service logic 612 and façade 616. In yet another example, event 624 may establish communication between context-specific service logic 612 and context-free management logic 614. Communication between façade 616 and other application component's façade may be established through event 628. In another example, event 626 may establish communication between context-free management logic 614 and façade 616. Also, communication between context-free management logic 614 and managed object 640 may be accomplished through event 630, for example. In accordance with the present invention, other communication mechanisms may also be used.

As part of an application component, Managed Object 640 may contain logic to perform management behaviors. Each managed object may act as a management view for an application component.

Managed Object 640 may include a managed object interpreter (“MOI”) 642. In addition, each managed object 640 may have one or more management components, which may include OM 644, Event Policy 646, Dependency 648 and other components.

Managed Objects in a system may send management events to an event concentrator which may be a single point of contact for all (or some) managed objects in the system.

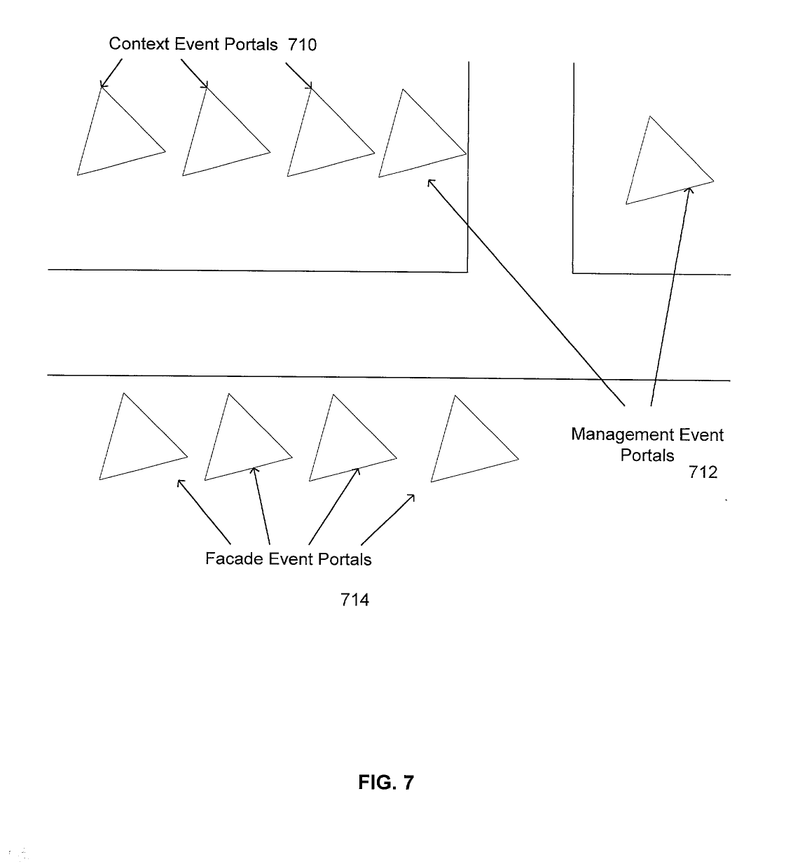

FIG. 7 illustrates an example of event portals, according to an embodiment of the present invention. Event portals may be a gateway through which one or more events may enter and/or exit the logic and other information of various parts of a managed resource. A collection of event portals may represent an interface for the various parts of a managed resource, as illustrated in FIG. 7. For example, event portals may include context event portals 710, management event portals 712, and façade event portals 714. Other types of portals may also be utilized, depending on the application and other relevant factors.

According to the present invention, application components may be wired together to establish communication. This may also be referred to as event subscription or context event subscription. Context event subscription may occur at runtime and may be established dynamically based on static event subscription definition. Event subscription may also involve registering to receive an event. When a software component (e.g., JavaBean) is interested in receiving a particular event, it may subscribe to receive that event from its source. An event subscription may be established (via event wiring) such that a specific event may be routed to an FSAC. The context free logic of the FSAC may receive this event and be responsible for determining if a new service context or a specific existing service context should receive the event. The context free logic may also process the event without invoking any context. Service interactions may be configured by connecting (via wiring) events between FSACs.

There may exist different levels of dependencies between application components. For example, dependencies may be intrinsic or extrinsic. Other levels of dependencies may also exist. Intrinsic dependencies may be part of the dependent application component and may therefore be stored in the definition of the application component, for example. This may occur when an application component uses a particular database table, JavaBean or software component.

Extrinsic dependencies may be defined by a wiring tool (or other tool) when a particular configured combination of application components is created. Since each application component may be used in a variety of configured combinations with different extrinsic dependencies in each environment, these dependencies may be stored separately from a given application component. The file in which extrinsic dependencies are be stored may be referred to as a wiring file. Wiring files which store configurations of application components should be stored and bundled separately from their underlying application components to enable independent delivery. For example, wiring files may refer to their application components using resource specifiers (in XML, for example) or other mechanism.

Other embodiments and uses of the invention will be apparent to those skilled in the art from consideration of the specification and practice of the invention disclosed herein. The specification and examples should be considered exemplary only.

What is claimed is:

1. A system for providing an application component where the application component enables a service to be managed as an independent entity comprising:
a context for containing logic and data associated with a service session;
a façade for containing context-independent service logic wherein the façade is not associated with the service session; and
an event portal for providing entry and exit interfaces.

2. The system of claim 1 further comprising management logic for defining operations, administration and management behavior.

3. The system of claim 1 further comprising management logic for defining appearance of the application component.

4. The system of claim 1 further comprising a wiring tool to configure a connection between the event portal of the application component to another event portal of a second application component.

5. The system of claim 4 wherein the wiring tool connects one or more outgoing events from the event portal to one or more incoming events of an event portal associated with the entity.

6. The system of claim 4 wherein the wiring tool provides the ability to create service variants by modifying connections between application components.

7. The system of claim 4 wherein the connection does not require hardcoding thereby enhancing flexibility in changing connections.

8. The system of claim 4 wherein wiring definitions are uploaded to a service execution engine wherein the service execution engine creates the connection.

9. The system of claim 1 wherein the application component is network independent.

10. The system of claim 1 wherein the application component encapsulates protocol specific interactions and presents a homogenous interface to other components.

11. The system of claim 1 wherein the application component is network independent and protocol independent.

12. The system of claim 4 wherein the connection is postponed until after the application component is created.

13. The system of claim 1 wherein the service comprises more than one application component where application components are developed by separate developers thereby enabling parallel development.

14. The system of claim 4 wherein runtime context event subscription is established dynamically based on static event subscription definition.

15. The system of claim 4 wherein contexts of different application components pertaining to a service session are maintained in a context envelope.

16. The system of claim 15 wherein the contexts are added dynamically to the context envelope as the contexts are invoked by service logic.

17. The system of claim 1 wherein one or more service variants are selected by the façade for each service session.

18. The system of claim 17 wherein the application component contains a single template which executes by default.

19. The system of claim 1 wherein the application component incorporates one or more of data storage schemas, variables, constants and configuration items.

20. The system of claim 19 wherein the one or more of data storage schemas, variables, constants and configuration items are exported from the application component.

21. The system of claim 19 wherein the one or more of data storage schemas, variables, constants and configuration items are imported by the application component.

22. The system of claim 20 wherein a wiring tool connects an exported item from the application component with an imported item in another application component.

23. The system of claim 1 wherein one or more protocol specific interactions are encapsulated to present a homogenous interface to other one or more application components.

24. A method for providing an application component where the application component enables a service to be managed as an independent entity comprising the steps of:
maintaining logic and data associated with the service in a context;
maintaining context-independent service logic in a façade wherein the façade is not associated with the service; and
providing entry and exit interfaces.

25. The method of claim 24 further comprising the step of enabling management logic to define operations, administration and management behavior.

26. The method of claim 24 further comprising the step of enabling management logic to defining appearance of the application component.

27. The method of claim 24 further comprising the step of providing a wiring tool to configure a connection between the event portal of the application component to another event portal of a second application component.

28. The method of claim 27 wherein the wiring tool connects one or more outgoing events from the event portal to one or more incoming events of an event portal associated with the entity.

29. The method of claim 27 wherein the wiring tool provides the ability to create service variants by modifying connections between application components.

30. The method of claim 27 wherein the connection does not require hardcoding thereby enhancing flexibility in changing connections.

31. The method of claim 27 wherein wiring definitions are uploaded to a service execution engine wherein the service execution engine creates the connection.

32. The method of claim 24 wherein the application component is network independent.

33. The method of claim 24 wherein the application component encapsulates protocol specific interactions and presents a homogenous interface to other components.

34. The method of claim 24 wherein the application component is network independent and protocol independent.

35. The method of claim 27 wherein the connection is postponed until after the application component is created.

36. The method of claim 24 wherein the service comprises more than one application component where application components are developed by separate developers thereby enabling parallel development.

37. The method of claim 27 wherein runtime context event subscription is established dynamically based on static event subscription definition.

38. The method of claim 27 wherein contexts of different application components pertaining to a service session are maintained in a context envelope.

39. The method of claim 38 wherein the contexts are added dynamically to the context envelope as the contexts are invoked by service logic.

40. The method of claim 24 wherein one or more service variants are selected by the façade for each service session.

41. The method of claim 40 wherein the application component contains a single template which executes by default.

42. The method of claim 24 wherein the application component incorporates one or more of data storage schemas, variables, constants and configuration items.

43. The method of claim 42 wherein the one or more of data storage schemas, variables, constants and configuration items are exported from the application component.

44. The method of claim 42 wherein the one or more of data storage schemas, variables, constants and configuration items are imported by the application component.

45. The method of claim 42 wherein a wiring tool connects an exported item from the application component with an imported item in another application component.

46. The method of claim 24 wherein one or more protocol specific interactions are encapsulated to present a homogenous interface to other one or more application components.
